(19) United States
(12) Patent Application Publication
(10) Pub. No.: US 2025/0002638 A1
(43) Pub. Date: Jan. 2, 2025

(54) RAPID-CURING COMPOSITION FOR THE PRODUCTION OF SEMI-FINISHED PRODUCTS ENABLING THE PRODUCTION OF COMPOSITE TYPE IV PRESSURE TANKS FOR THE ON-BOARD STORAGE OF HYDROGEN GAS

(71) Applicants: COMMISSARIAT A L'ENERGIE ATOMIQUE ET AUX ENERGIES ALTERNATIVES, Paris (FR); INSTITUT NATIONAL DES SCIENCES APPLIQUÉES DE LYON, Villeurbanne (FR); VITECH COMPOSITES, Sainte-Maure-de-Touraine (FR); CENTRE NATIONAL DE LA RECHERCHE SCIENTIFIQUE, Paris (FR); UNIVERSITE CLAUDE BERNARD – LYON1, Villeurbanne (FR); UNIVERSITE JEAN MONNET SAINT ETIENNE, Saint-Etienne (FR)

(72) Inventors: Christophe Magnier, Monts (FR); Stéphane Villalonga, Monts (FR); Martin Jegou, Arronville (FR); Sébastien Livi, Villeurbanne (FR); Jean-François Gerard, Bron (FR); Jannick Duchet-Rumeau, Sainte-Euphemie (FR); Frédéric Demaret, Pouzay (FR)

(73) Assignees: COMMISSARIAT A L'ENERGIE ATOMIQUE ET AUX ENERGIES ALTERNATIVES, Paris (FR); INSTITUT NATIONAL DES SCIENCES APPLIQUÉES DE LYON, Villeurbanne (FR); VITECH COMPOSITES, Sainte-Maure-de-Touraine (FR); CENTRE NATIONAL DE LA RECHERCHE SCIENTIFIQUE, Paris (FR); UNIVERSITE CLAUDE BERNARD – LYON1, Villeurbanne (FR); UNIVERSITE JEAN MONNET SAINT ETIENNE, Saint-Etienne (FR)

(21) Appl. No.: 18/709,986

(22) PCT Filed: Nov. 16, 2022
(86) PCT No.: PCT/EP2022/082161

§ 371 Date: May 14, 2024

(30) Foreign Application Priority Data
Nov. 17, 2021 (FR) FR2112167

(51) Int. Cl. C08G 59/40; C08J 5/24; F17C 1/16

(52) U.S. Cl. CPC C08G 59/4071; C08J 5/24; F17C 1/16; C08J 2363/00; F17C 2203/012; F17C 2203/0604; F17C 2203/066; F17C 2203/0673; F17C 2203/0675; F17C 2209/2109; F17C 2209/2154; F17C 2209/232; F17C 2221/012; F17C 2223/0123; F17C 2223/035; F17C 2260/011

(57) ABSTRACT

Embodiments of the disclosure relate to a composition including 70 to 95 parts by weight of an epoxide resin having a viscosity of between 1 and 150 kPa·s at a temperature of between 20° C. and 25° C., and 5 to 30 parts by weight, per 100 parts by weight of resin present in the composition, of a curing agent dispersed in the resin, the curing agent being an ionic liquid containing a phosphonium cation. The disclosure also relates to a semi-finished product or towpreg, including a bundle of fibres and a composition. The disclosure also relates to the use of a composition or of a semi-finished product according to the disclosure for the production of a hydrogen tank, in particular a type IV pressure tank, made of composite material, for the on-board storage of hydrogen gas.

### TECHNICAL FIELD OF THE INVENTION

This invention relates to the field of manufacturing type-IV pressure vessels, made of composite material, for the storage of gaseous hydrogen, for both fixed and mobile applications, such as for example, hydrogen storage infrastructures, the transport of hydrogen for refuelling, hydrogen rail vehicles, buses, trucks, planes, boats and other hydrogen vehicles, and hydrogen cars.

### TECHNICAL BACKGROUND

Though on-board systems for the storage of gaseous hydrogen in pressure vessels for transport applications currently exist, only a few manufacturers market a few thousand approved vessels per year. With the emergence of the market associated with low-carbon mobility and with pressure storage, there is no supply chain (transformation of raw materials and components into a finished product which is delivered to the end customer) suitable for mass production (millions of units per year) at a reasonable cost. For example, the compact, reliable, safe and economical storage of hydrogen gas below 700 bar is a major challenge for the widespread commercialisation of Fuel Cell Electric Vehicles (FCEV) and other fuel cell applications. While some lightweight FECVs with a range of more than 500 km have appeared since 2015, affordable on-board hydrogen storage still remains a major obstacle and the quantity of vessels manufactured remains low. Most of the efforts in hydrogen storage programmes focus on developing cost-effective hydrogen storage technologies with improved energy density (gravimetric capacity close to 6%, i.e. 6% of the mass of the storage system is hydrogen).

Hydrogen vessels for automotive applications, buses, trucks, trains, planes and boats already exist but they do not yet meet all the expectations of manufacturers in terms of mass-producing hydrogen-powered systems. This is true with regards to the manufacture of H₂ vessels but also for the deployment and use of fuel cell transport means.

Even though the manufacturing cost of type-IV pressure vessels made of composite material for the on-board storage of gaseous hydrogen only represents approximately 10% to 30% of the cost of the storage system, the mass production capacity is a major challenge for automotive integrators. The polymerisation (or hardening) stage of the composite material matrix ensuring resistance to high pressure is the main stage currently limiting the speed with which vessels can be manufactured. The composite material matrix of composite pressure vessels is generally an epoxy matrix.

In order to produce several million vehicles per year, the polymerisation (or hardening) time of the composite matrices for type-IV vessels must be considerably reduced.

Currently, with epoxy matrices, the duration of the polymerisation (or hardening) process for a 700-bar pressure vessel is approximately 12 to 16 hours, which is too long for mass production such as that required for the automotive industry.

There is therefore a real need to make the manufacture of type-IV pressure vessels made of composite material for the on-board storage of gaseous hydrogen efficient for mass production and industrially relevant.

In particular, there is a real need to significantly reduce the duration of the polymerisation (or hardening) step of the composite material matrix to minimise the cycle time for manufacturing a vessel.

To achieve this, this invention proposes a novel composition for the composite material which takes into account the technical and regulatory limitations associated with high-pressure composite vessels for on-board hydrogen storage.

### SUMMARY OF THE INVENTION

This invention relates to a composition (C) comprising
(A) 70 to 95 parts by mass of an epoxy resin with a viscosity of between 1 Pa·s and 150 kPa·s at a temperature of between 20° C. and 25° C., and
(B) 5 to 30 parts by mass of a hardener dispersed in the resin,
per 100 parts by mass of resin present in the composition,
characterised in that the hardener is an ionic liquid containing a phosphonium cation of formula P(R₁R₂R₃R₄)⁺ wherein R₁, R₂, R₃ et R₄, identical or different, represent a hydrogen atom, an alkyl radical having 1 to 18 carbon atoms, an aryl radical having 6 to 20 carbon atoms, said alkyl and aryl radicals being optionally substituted.

The type-IV high pressure vessel, made of composite material, comprises an internal layer of polymer material, called a bladder or liner, generally thermoplastic, with metal connectors, called bosses, at one or both ends. The bosses provide the connection between the vessel and the storage system. The liner provides hydrogen tightness. This assembly is covered with a structuring composite material, ensuring structuring under internal pressure, usually comprising a thermosetting matrix, generally an epoxy resin, and a reinforcement generally based on long fibres, for example, carbon or glass fibres.

This invention therefore aims to support the development of on-board storage systems for gaseous hydrogen (CGH₂ compressed gaseous hydrogen, CPV Composite Pressure Vessel) in pressure vessels which are enhanced, in order to anticipate the future mass deployment of the aforementioned technologies, in particular by focusing on the composition of the composite material of the vessel, and more precisely on the resin and its polymerisation reaction which significantly impacts manufacturing rates over periods of more than 10 hours in general.

The composition of the invention is particularly advantageous because polymerisation (or hardening) is quick compared with the compositions based on epoxy matrices used currently, and this is in particular thanks to the use of phosphorus ionic liquids such as hardener. Indeed, the duration of polymerisation (or hardening) of the epoxy matrix in a composition according to the invention is less than 12 hours, less than 10 hours, in particular less than 8 hours, and more particularly less than 6 hours.

Another object of the invention is a semi-finished product called a towpreg, characterised in that it comprises
a fibre bundle (F) selected from among carbon, glass, aramid, silicon carbide, organic fibres and
a composition (C) according to the invention,
said fibre bundle being impregnated by said composition, and
the volume content of (F) is between 40 and 70% and the volume content of (C) is between 30 and 60%.

The fibre bundle can be in the form of a sheet or aggregate of non-woven loose fibres, or in woven form.

The semi-finished product or towpreg can be polymerised after the fibres (F) are impregnated by the composition (C).

The semi-finished product or towpreg can be optionally wound on a spool after the fibres (F) are impregnated by the composition (C) and after the polymerisation (or hardening) thereof.

The composition (C) and the semi-finished product or towpreg according to the invention can be used for the manufacture of type-IV pressure vessels, made of composite material, for the on-board storage of gaseous hydrogen, in particular for both fixed and mobile applications, such as for example, hydrogen storage infrastructures, the transport of hydrogen for refuelling, hydrogen rail vehicles, buses, trucks, planes, boats and other hydrogen vehicles, and hydrogen cars.

Another object of the invention is the use of a composition (C) or a semi-finished product, according to the invention, for the manufacture of a hydrogen vessel, in particular a type-IV pressure vessel, made of composite material, for the on-board storage of gaseous hydrogen.

Another object of the invention is a structure, made of composite material, comprising a polymerised semi-finished product or towpreg.

More particularly, the structure is a pressure vessel.

Preferably, the vessel is a type-IV pressure vessel for the on-board storage of gaseous hydrogen.

The invention also relates to a method of manufacturing a hydrogen vessel, in particular a type-IV pressure vessel comprising a step to achieve the desired shape of a composition according to the invention and not polymerised, followed by a step to polymerise this composition brought into the desired shape.

But another method of manufacturing, according to the invention, a hydrogen vessel, in particular a type-IV pressure vessel, comprises a step to achieve the desired shape of a composition according to the invention and already polymerised.

Yet another method of manufacturing, according to the invention, a hydrogen vessel, in particular a type-IV pressure vessel, comprises a step to achieve the desired shape of the semi-finished product according to the invention, followed by a step to polymerise this semi-finished product brought into shape.

### DETAILED DESCRIPTION OF THE INVENTION

This invention relates to a composition (C), characterised in that it comprises:
(A) 70 to 95 parts by mass of an epoxy resin with a viscosity of between 1 Pa·s and 150 kPa·s at a temperature of between 20° C. and 25° C., and
(B) 5 to 30 parts by mass of a hardener dispersed in the resin,
per 100 parts by mass of resin present in the composition,
characterised in that the hardener is an ionic liquid containing a phosphonium cation of formula P(R₁R₂R₃R⁴)⁺ wherein R₁, R₂, R₃ et R4, identical or different, represent a hydrogen atom, an alkyl radical having 1 to 18 carbon atoms, an aryl radical having 6 to 20 carbon atoms, said alkyl and aryl radicals being optionally substituted.

The term “alkyl”, according to this invention, means a linear, branched or cyclic, saturated, optionally substituted, carbon radical comprising 1 to 18 carbon atoms, for example, 1 to 14 carbon atoms, for example 1 to 12 carbon atoms, for example 1 to 6 carbon atoms. Examples of saturated, linear or branched alkyl include the radicals methyl, ethyl, propyl, butyl, pentyl, hexyl, octyl, nonyl, decyl, undecyl (C₁₁, dodecanyl (or dodecyl (C₁₂)), tridecyl (C₁₃), tetradecyl (C₁₄) and branched isomers thereof. Examples of cyclic alkyl include the radicals cyclopropyl, cyclobutyl, cyclopentyl, cyclohexyl, cycloheptyl, cyclooctyl, bicylco[2,1,1]hexyl, bicyclo[2,2, 1]heptyl.

The term “aryl” designates a mono-or poly-cyclic aromatic substituent comprising 6 to 20 carbon atoms, for example, 6 to 10 carbon atoms. By way of indication, examples include phenyl, benzyl, naphthyl and phenanthrenyl groups.

The alkyl and aryl radicals can optionally be substituted by one or more hydroxyl groups (-OH), one or more alkoxy groups (—O-alkyl); one or more aryloxy groups (—O-aryl); one or more halogen atoms selected from among fluorine, chlorine, bromine and iodine atoms; with alkyl, and aryl as defined in the context of the present invention.

In one embodiment, in the phosphonium cation, R₁, R₂, R₃ and R₄, identical or different, represent:
a hydrogen atom,
an alkyl radical selected from among methyl, ethyl, propyl, butyl, pentyl, hexyl, heptyl, octyl, nonyl, decyl, undecyl dodecyl, tridecyl, tetradecyl, and branched isomers thereof,
an aryl radical selected from among phenyl, benzyl,
said alkyl and aryl radicals being optionally substituted.

The phosphonium cation can be selected from among PH₄⁺, P(CH₃)₄⁺, P(Ph)₄⁺, P(CH₃)(Ph)₃⁺, P(CH₂OH)₄⁺.

The phosphonium cation can also be selected from among PH₄⁺, P(CH₃)₄⁺, P(Ph)₄⁺, P(CH₃)(Ph)₃⁺, P(CH₂OH)₄⁺, P(C₆H₁₃)₃(C₁₄H₂₉)⁺.

More particularly, the phosphonium cation is trihexyl (tetradecyl) phosphonium or P(C₆H₁₃)₃(C₁₄H₂₉)⁺.

According to one embodiment of the invention, in the composition, the ionic liquid contains a dicyanamide anion (C₂N₃).

In this embodiment, the composition (C) comprises 10 to 30 parts by mass of ionic liquid, per 100 parts by mass of epoxy resin present in the composition.

In all variants and embodiments of the invention, the composition (C) can be polymerised under the effect of temperature depending on the desired application and the desired characteristics. A person skilled in the art will know how to choose and adjust these conditions.

According to another embodiment of the invention, the composition comprises an ionic liquid which contains a phosphinate anion of formula (PO₂R₅R₆) wherein R₅ and R₆, identical or different, represent a hydrogen atom, an alkyl radical having 1 to 18 carbon atoms, an aryl radical having 6 to 20 carbon atoms, said alkyl and aryl radicals being optionally substituted.

In this other embodiment, in the phosphinate anion, R₅ and R₆, identical or different, represent:
a hydrogen atom,
an alkyl radical selected from among methyl, ethyl, propyl, butyl, pentyl, hexyl, heptyl, octyl, and branched isomers thereof,
an aryl radical selected from among phenyl, benzyl,
said alkyl and aryl radicals being optionally substituted.

The phosphinate anion can be selected from among (PO₂H₂)⁻, (PO₂(CH₃)₂)⁻, (PO₂(C₇H₃₀)₂)⁻, (PO₂Ph₂)⁻.

The phosphinate anion can also be selected from among (PO₂H₂)⁻, (PO₂(CH₃)₂)⁻, (PO₂(C₇H₃₀)₂)⁻, (PO₂Ph₂)⁻, bis(2,4,4-trimethylpentyl)phosphinate or (PO₂(CH₂—CH(CH₃)—CH₂—C(CH₃)₃)₂)⁻.

In this other embodiment, when the ionic liquid contains a phosphinate anion as described above, the composition comprises 5 to 20 parts by mass of ionic liquid, per 100 parts by mass of epoxy resin present in the composition.

The epoxy resin (A) present in the composition can be, for example, of the bisphenol type, such as bisphenol A, bisphenol B, bisphenol F, bisphenol S, ortho-, meta-, para-cresol novolac.

The epoxy resin (A) has a viscosity of between 1 Pa·s and 150 kPa·s at a temperature of between 20° C. and 25° C. The epoxy resin (A) can be, for example, a resin with a viscosity of 16.9 kPa·s (+/−20%) at 25° C. and 113.0 kPa·s at 20° C.

Viscosity is measured at a temperature between 20° C. and 25° C., using an ARES Rheometer device, by the company TA® instruments, Brookfield LV DV I+ by the company BROOKFIELD ENGINEERING LABORATORIES, INC. The ARES rheometer uses a plane/plane geometry with aluminium discs of 25 mm (upper geometry) and 40 mm (lower geometry). The composition is applied hot (60° C.) to the geometries then cooled to a temperature between 20° C. and 25° C. to carry out the viscosity measurement. The “DFS” Dynamic Frequency Sweep (strain controlled) 1-100 rad/s test is carried out with a deformation of approximately 1%. The viscosity measurement is recorded for a frequency of 1 rad/s.

The composition according to the invention can be prepared by mixing components (A) and (B) as indicated in the examples. In particular, the method consists of mixing an epoxy resin (A) and an ionic liquid (B) as defined above, until a homogeneous composition is obtained, at a temperature which does not require the initiation of the polymerisation of (A).

The composition can be prepared in a simple reactor (made of glass) provided with a stirring blade and in the presence of air. The temperature can be controlled by a heater plate and a silicone oil bath.

Continuous mixing is a method for continuously dispensing ingredients directly into the mixing zone and, consequently, generating a continuous flow of mixed product at the outlet of the mixer. This principle guarantees perfect control of the point at which the ingredients meet and therefore a unique distribution quality for the mixed product. The product obtained is therefore in the form of a homogeneous mixture. Any continuous mixer known to those skilled in the art may be suitable for manufacturing the composition.

Not wishing to be bound by theory, the inventors have noted that the use of ionic liquids as hardeners in a composition according to the invention allows crosslinking via a catalytic mechanism and not an addition mechanism. In addition to shorter cooking times, ionic liquids can be used to reduce the quantity of polymerisation (or hardening) agent required for the complete crosslinking of the epoxy matrix (i.e. 20-50 parts per 100 parts of resin or phr, for standard amine systems). Indeed, the ionic liquid, due to the temperature, will allow the opening of the oxirane ring thanks to the nucleophilic attack of the anion on the a carbon of this function.

This so-called activation reaction leads to the formation of alkoxide, reactive function with respect to other epoxy motifs. A second so-called propagation step consists of the homopolymerisation of the alkoxide motifs formed on the oxirane rings.

Under suitable temperature conditions, this reaction continues until the complete crosslinking of the epoxy matrix is achieved (conversion>95%).

Another object of the invention is a semi-finished product also called a towpreg, characterised in that it comprises:
a fibre bundle (F) selected from among carbon, glass, aramid, silicon carbide, organic fibres and
a composition (C) according to the invention,
said fibre bundle being impregnated by said composition, and
the volume content of (F) is between 40 and 70% and the volume content of (C) is between 30 and 60%.

The terms “semi-finished product” and “towpreg” are interchangeable and can be used interchangeably to describe the same product.

By organic fibres we mean carbon-and hydrogen-based fibres. These can be natural (cellulose, silk, linen), derived from cellulose (cellulose acetate, etc.), synthetic (polyester, polyethylene etc.).

The fibre bundle can be in the form of a sheet or aggregate of non-woven loose fibres, or in woven form.

The bundle of reinforcing fibres preferably comprises 1000 to 70,000 filaments with a diameter of 3 to 100 μm.

Preferably, the fibres (D) are carbon fibres. An example of this includes TORAYCA T720 carbon fibres from the company Toray®.

The semi-finished product also called towpreg, as its name suggests, is an intermediate product, intended for use in the manufacture of composite material structures, such as for example type-IV pressure vessels made of composite material, particularly after hot moulding.

The semi-finished product or towpreg can be manufactured by a continuous production method comprising the steps of
(i) heating a composition (C) comprising the resin (A) and the ionic liquid (B) at a temperature of between 40 and 60° C., and
(ii) continuous impregnation of the moving fibre bundle (F) by the composition (C).

Thus, continuous production is carried out without interruption, by a continuous flow of composition and fibres (F), and is concentrated in a single location. The final product, here the semi-finished product or towpreg, is discharged without interrupting the process.

The continuous impregnation of the fibre bundle (F) by the composition (C) takes place at a temperature which can range from 20° C. to 80° C.

The duration of this impregnation can range from a few seconds to a few minutes, for example, 10 seconds to 5 minutes.

After step (ii), the impregnated fibres are cooled to a temperature below 30° C.

In step (ii), the fibre bundle (E) can be impregnated by the composition (C) in several ways, by methods well known to those skilled in the art, including by spraying, immersion or transfer.

Once manufactured, the semi-finished product or towpreg can be stored as is. The semi-finished product can also be wound, for example on a spool.

The semi-finished product can be used for filament winding on a polymer bladder or liner, in particular a polyethylene or polyamide bladder or liner.

The bladder (or liner) can be that of a vessel, for example a hydrogen vessel, in particular a type-IV pressure vessel, made of composite material, for the on-board storage of gaseous hydrogen.

The invention also relates to the use of a composition (C) according to the invention, or of a semi-finished product or towpreg according to the invention, for the manufacture of a hydrogen vessel, in particular a type-IV pressure vessel made of composite material, for the on-board storage of gaseous hydrogen, in particular for both fixed and mobile applications, such as, for example, hydrogen storage infrastructures, the transport of hydrogen for refuelling, hydrogen rail vehicles, buses, trucks, planes, boats and other hydrogen vehicles, and hydrogen cars.

The invention also relates to a method of manufacturing a hydrogen vessel, in particular a type-IV pressure tank comprising a step to shape a composition (C) according to the invention.

In a first embodiment of this method, the composition (C) is introduced unpolymerised into a mould having the desired size and shape of the hydrogen vessel to be obtained and is then polymerised.

In a second embodiment of this method, the already polymerised composition (C) is given the desired size and shape of the hydrogen vessel, for example by machining.

Another object of the invention is a structure, made of composite material, comprising a polymerised semi-finished product or towpreg.

Polymerisation can be carried out using polymerisation methods known to those skilled in the art, for example under the effect of temperature.

More particularly, the structure is a pressure vessel.

Preferably, the vessel is a type-IV pressure vessel for the on-board storage of gaseous hydrogen.

According to one embodiment, the polymerised towpreg is wound on a polymer bladder or liner, in particular a polyethylene bladder or liner.

According to another embodiment, the polymerised towpreg is wound on a polymer bladder or liner, in particular a polyamide bladder or liner.

Preferably, the vessel is a type-IV pressure vessel for the on-board storage of gaseous hydrogen.

Thus, the invention also relates to a method of manufacturing a hydrogen vessel, in particular a type-IV pressure vessel, comprising a step of shaping the semi-finished product according to the invention, followed by a step to polymerise the semi-finished product according to claim 9 brought into shape.

The composition (C) according to the invention cooks quickly (only a few hours) during the manufacture of type-IV pressure composite vessels for the on-board storage of gaseous hydrogen. The quick cooking of the composition is substantially due to the use of ionic liquid as a hardener.

The composition of the invention comprises an epoxy resin (A) because this type of thermosetting polymer is most commonly used for the manufacture of pressure vessels for on-board hydrogen storage.

It is adapted to have the characteristics required to allow the manufacture of a semi-finished product called towpreg using the hot-melt method, by impregnation of the bundles/sheets of carbon fibres, for example. This semi-finished product or towpreg, which can be in spool form, is then used to manufacture the vessels. Once applied around the bladder or liner, most often by filament winding, the epoxy matrix is then polymerised generally in an oven or tunnel oven. The vessels thus obtained can be approved according to the criteria of the regulations currently in force (406 2010, R₁₃₄).

### EXAMPLES

### Protocol for Preparing a Composition According to the Invention

The SR 1228 resin, marketed by the company Sicomin, and of the hot-melt type has a viscosity of 113 kPa·s at 20° C. Sicomin SR 1228 resin is semi-solid and non-crystalline at room temperature (20° C.-25° C.). Therefore, in order to use it, it needs to be heated at around 50° C.

The resin is introduced into a thermostatically controlled reactor then the ionic liquid Cyphos® LI 105 (trihexyl (tetradecyl) phosphonium dicyanamide), marketed by the company Strem Chemicals, is added in an amount of 15 parts by weight phr (15 parts Cyphos® LI 105 for 100 parts of SR 1228 resin). The mixture is stirred for approximately 30 minutes at 60° C.

Once homogenised, a composition according to the invention is obtained and can be used for impregnating reinforcing fibres. During this step, the composition is sprayed continuously onto a TORAYCA T720 carbon fibre tow from the company Toray® at a temperature of between 60 and 80° C. maximum.

The tow impregnated with the composition (resin+ionic liquid) can then be wound in the form of a semi-finished product or towpreg and left to cool as is. Storage should take place in a clean and dry area, protected from light, up to a temperature of 20° C. Under these conditions, and depending on the ionic liquid used, the invention makes it possible to guarantee a life span of the semi-finished product or towpreg of at least two weeks and up to more than four weeks.

### Cooking Cycle

The cooking cycles proposed for the polymerisation of a composition as prepared above last 5 hours with a polymerisation step lasting 0.5 hours at 100° C., then 1.5 hours at 120° C., then 2 hours at 130° C.

In summary, the compositions according to the invention can be used for the preparation of towpreg usable within 2 to 4 weeks for filament winding applications for type-IV hydrogen vessels. These compositions address the issue of cooking times by offering polymerisation times of less than 5 hours for thick composites (>30 mm). In addition, these compositions can be used with both PE (polyethylene) and PA (polyamide) liners, the two main polymer materials used to manufacture hydrogen vessels. Finally, these compositions can be used to replace amine hardeners, which are unfavourable in terms of health.

1. A composition comprising:
70 to 95 parts by mass of an epoxy resin with a viscosity of between 1 Pa·s and 150 kPa·s at a temperature of between 20° C. and 25° C., and
5 to 30 parts by mass of a hardener dispersed in the resin, per 100 parts by mass of resin present in the composition,
wherein the hardener is an ionic liquid containing a phosphonium cation of formula P(R₁R₂R₃R₄)⁺ wherein R₁, R₂, R₃ and R₄, identical or different, represent a hydrogen atom, an alkyl radical having 1 to 18 carbon atoms, an aryl radical having 6 to 20 carbon atoms, said alkyl and aryl radicals being optionally substituted.

2. The composition according to claim 1, wherein the phosphonium cation is selected from the group consisting of PH₄⁺, P(CH₃)₄⁺, P(Ph)₄⁺, P(CH₃)(Ph)₃⁺, P(CH₂OH)₄⁺, and P(C₆H₁₃)₃(C₁₄H₂₉)⁺.

3. The composition according to claim 1, wherein the ionic liquid contains a dicyanamide anion (C₂N₃)⁻.

4. The composition according to claim 3, comprising 10 to 30 parts by mass of ionic liquid, per 100 parts by mass of epoxy resin present in the composition

5. The composition according to claim 1, wherein the ionic liquid contains a phosphinate anion of formula (PO₂R₅R₆) wherein R₅ and R₆, identical or different, represent a hydrogen atom, an alkyl radical having 1 to 18 carbon atoms, an aryl radical having 6 to 20 carbon atoms, said alkyl and aryl radicals being optionally substituted.

6. The composition according to claim 5, wherein the phosphinate anion is selected from the group consisting of (PO₂H₂)⁻, (PO₂(CH₃)₂)⁻, (PO₂(C₇H₃₀)₂)⁻, (PO₂Ph₂)⁻, and (PO₂(CH₂—CH(CH₃)—CH₂—C(CH₃)₃)₂)⁻.

7. The composition according to claim 5, comprising 5 to 20 parts by mass of ionic liquid, per 100 parts by mass of epoxy resin present in the composition.

8. The composition according to claim 1, wherein the epoxy resin has a viscosity of 16.9 kPa·s (+/−20%) at 25° C. and of 113.0 kPa·s at 20° C.

9. A semi-finished product, comprising:
a fiber bundle selected from the group consisting of carbon, glass, aramid, silicon carbide, and organic fibres, and
a composition according to claim 1,
wherein said fiber bundle is impregnated by said composition, and wherein the volume content of the fiber bundle is between 40 and 70% and the volume content of the composition is between 30 and 60%.

10. (canceled)

11. A structure, made of composite material, comprising a polymerized semi-finished product according to claim 9.

12. The structure according to claim 11, wherein the structure is a type-IV pressure vessel for the on-board storage of gaseous hydrogen.

13. A method of manufacturing a hydrogen vessel, the method comprising:
achieving a desired shape of a composition according to claim 1 without polymerization, thereafter
polymerizing the composition.

14. A method of manufacturing a hydrogen vessel, the method comprising:
polymerizing the composition according to claim 1; thereafter
achieving a desired shape of the polymerized composition.

15. A method of manufacturing a hydrogen vessel, in particular a type-IV pressure vessel, the method comprising:
achieving a desired shape of the semi-finished product according to claim 9; and thereafter
polymerizing the semi-finished product.
